(19) United States
(12) Patent Application Publication
(10) Pub. No.: US 2026/0325973 A1
(43) Pub. Date: Oct. 22, 2026

(54) VIRTUAL PET CHARACTER CONTROL METHOD AND APPARATUS, DEVICE, AND MEDIUM

(71) Applicant: Tencent Technology (Shenzhen) Company Limited, Shenzhen (CN)

(72) Inventors: Yang CHEN, Shenzhen (CN); Chunyang WANG, Shenzhen (CN); Zhaoxiong JIANG, Shenzhen (CN); Xinyu YIN, Shenzhen (CN)

(21) Appl. No.: 19/713,438

(22) Filed: Jun. 18, 2026

Related U.S. Application Data
(63) Continuation of application No. PCT/CN2025/108566, filed on Jul. 15, 2025.

(30) Foreign Application Priority Data
Aug. 19, 2024 (CN) 202411142131.3

(51) Int. Cl. A63F 13/58; A63F 13/825; G06F 3/04817

(52) U.S. Cl. CPC A63F 13/58; A63F 13/825; G06F 3/04817; A63F 2300/308

(57) ABSTRACT

This application discloses a method for controlling a virtual pet character in a virtual scene performed by a computer device. The method includes: displaying a graphical user interface including a virtual pet character located in a virtual scene, the virtual pet character having a first evolution stage and a second evolution stage and being currently in the first evolution stage; in response to receiving a degeneration operation, controlling the virtual pet character to degenerate from the first evolution stage to the second evolution stage and generating an instant battle effect corresponding to the degeneration operation for the virtual pet character, wherein the virtual pet character in the second evolution stage is visually different from the virtual pet character in the first evolution stage; and applying the instant battle effect to enhance an attack launched by the virtual pet character against an opponent pet character.

### CROSS-REFERENCE TO RELATED APPLICATIONS

This application is a continuation application of PCT Patent Application No. PCT/CN2025/108566, entitled “VIRTUAL PET CHARACTER CONTROL METHOD AND APPARATUS, DEVICE, AND MEDIUM” filed on Jul. 15, 2025, which claims priority to Chinese Patent Application 202411142131.3, entitled “VIRTUAL PET CHARACTER CONTROL METHOD AND APPARATUS, DEVICE, AND MEDIUM” filed on Aug. 19, 2024, both of which are incorporated herein by reference in their entirety.

### FIELD OF THE TECHNOLOGY

Embodiments of this application relate to the field of virtual environments, and in particular, to a virtual pet character control method and apparatus, a device, and a medium.

### BACKGROUND OF THE DISCLOSURE

An open-world game is a type of game that supports a high degree of player exploration within a game world. A map scope of the open-world game is often vast. During exploration of the open world, a player-controlled virtual character often engage in various battles. In a battle scene, a virtual pet character belonging to the player-controlled virtual character battles against an opponent pet character.

In the related art, in the battle between the virtual pet character and the opponent pet character, specific resource costs are required for affecting the battle between the two parties. For example, a specific quantity of magic points are required for controlling the virtual pet character to cast a skill.

The consumable resource costs in the related art are limited in variety. How to provide more resource costs capable of affecting a battle has become an urgent technical problem to be solved.

### SUMMARY

This application provides a virtual pet character control method and apparatus, a device, and a medium. In this application, an evolution stage is used as a resource cost, and a battle effect capable of affecting a battle is generated by consuming the evolution stage of a virtual pet character. The technical solutions are described as follows:

According to an aspect of this application, a virtual pet character control method is performed by a computer device and the method includes:
displaying a virtual pet character located in a virtual scene, the virtual pet character having at least a first evolution stage and a second evolution stage, the virtual pet character being currently in the first evolution stage, and the first evolution stage being higher than the second evolution stage;
in response to receiving a degeneration operation, controlling the virtual pet character to degenerate from the first evolution stage to the second evolution stage and generating an instant battle effect corresponding to the degeneration operation for the virtual pet character, wherein the virtual pet character in the second evolution stage is visually different from the virtual pet character in the first evolution stage; and
applying the instant battle effect to enhance an attack launched by the virtual pet character against an opponent pet character.

According to an aspect of this application, a computer device is provided. The computer device includes a processor and a memory. The memory has a computer program stored therein, and the computer program, when loaded and executed by the processor, causes the computer device to implement the virtual pet character control method described above.

According to another aspect of this application, a non-transitory computer-readable storage medium is provided. The storage medium has a computer program stored therein, and the computer program, when loaded and executed by a processor of a computer device, causes the computer device to implement the virtual pet character control method described above.

The technical solutions provided in the embodiments of this application achieve at least the following beneficial effects.

Through the degeneration operation, the virtual pet character is degenerated from a higher evolution stage (the first evolution stage) to a lower evolution stage (the second evolution stage), and the battle effect configured for affecting the virtual battle between the virtual pet character and the opponent pet character is generated. In this way, the evolution stage of the virtual pet character is implemented as a type of virtual resource, and a battle effect bonus is obtained by consuming the evolution stage of the virtual pet character. The evolution stage of the virtual pet character is implemented as a type of virtual resource, to provide a novel type of virtual resource in a virtual environment. This enriches types of virtual resources in the virtual environment. The virtual resource, namely, the evolution stage, is allocated through the degeneration operation. This enriches battle strategies in the virtual environment.

### BRIEF DESCRIPTION OF THE DRAWINGS

FIG. 1 is a structural block diagram of a computer system according to an exemplary embodiment.

FIG. 2 is a schematic diagram of a virtual pet character control method according to an exemplary embodiment.

FIG. 3 is a flowchart of a virtual pet character control method according to an exemplary embodiment.

FIG. 4 is a schematic diagram of a virtual pet character control method according to an exemplary embodiment.

FIG. 5 is a schematic diagram of a virtual pet character control method according to an exemplary embodiment.

FIG. 6 is a flowchart of a virtual pet character control method according to an exemplary embodiment.

FIG. 7 is a flowchart of a virtual pet character control method according to an exemplary embodiment.

FIG. 8 is a schematic diagram of a virtual pet character control method according to an exemplary embodiment.

FIG. 9 is a structural block diagram of a virtual pet character control apparatus according to an exemplary embodiment.

FIG. 10 is a structural block diagram of a computer device according to an exemplary embodiment.

### DESCRIPTION OF EMBODIMENTS

Exemplary embodiments are described in detail herein, and examples of the exemplary embodiments are shown in the drawings. When the following description involves the drawings, unless otherwise denoted, the same numerals in different drawings denote the same or similar elements. Implementations described in the following exemplary embodiments do not represent all implementations consistent with this application. Instead, the implementations are merely examples of apparatuses and methods that are described in detail in the appended claims and that are consistent with some aspects of this application.

Information (including but not limited to equipment information, personal information, and the like) and data (including but not limited to data for analysis, stored data, displayed data, and the like) that are involved in this application are all information and data authorized by objects or fully authorized by all parties, and collection, use, and processing of related data need to comply with related laws, regulations, and standards of related countries and regions.

First, terms involved in the embodiments of this application are briefly introduced.

Open-world game: In an embodiment, the open-world game refers to a game that supports a high degree of player exploration within a game world, and a map scope of the open-world game is often vast. In this application, a map in the open-world game is referred to as a world map.

Round-based battle: In an embodiment, the round-based battle refers to a battle mode in which two parties perform attack, defense, or attribute improvement in turn according to a round sequence. Different from an instant battle mode, the round-based battle pays more attention to a sequence in a battle process. A complete round in the round-based battle means that all faction in a battle perform active operations of attack, defense, or attribute improvement in turn. In some cases, a complete round means that a faction A completes an active operation of attack, defense, or attribute improvement. In this application, a map in the turn-based battle is referred to as a battle map.

World map: In an embodiment, the world map includes a plurality of land masses. Each land mass is a polygonal land mass. The polygonal land mass may be any one of a square, a rectangle, and a hexagon. For example, each land mass is a 50 cm×50 cm square. Each land mass has its own terrain. Terrain types include grass, stone, water, and the like. In addition, the plurality of land masses included in the world map may be a combination of land masses of a same type or a combination of a plurality of land masses of different types.

In an embodiment, time in the open-world game is controlled a Time of Day (TOD, 24-hour time) system. Under the control of the TOD system, the world map features time-related factors such as weather, day-night cycles, seasons, festivals, and so on.

Battle map: In an embodiment, the battle map is a partial map of the world map. When the round-based battle starts, the battle map in a battle scene share a same piece of map data with the world map in the virtual scene share same map data. In an embodiment, before the round-based battle starts, a world server loads map data of the world map, and when the round-based battle starts, a battle server loads data of a partial map of the world map. In this way, the battle map shares the same piece of map data with the partial map. In a virtual environment, when a virtual pet character encounters a wild virtual character at a position on the world map and initiates a battle, one or more land masses within a specific range with a reference position of the virtual pet character on the world map as a center are determined as the battle map. The reference position is a position of the virtual pet character or a suitable battle position closest to the virtual pet character. In some embodiments, the battle map includes all land masses within a circular range with the reference position as a center and a predetermined length as a radius. In some embodiments, the battle map includes all land masses within a rectangular range with the reference position as a center and a predetermined length and a predetermined width.

World scene and battle scene: The virtual scene refers to a scene corresponding to the world map. During display of the virtual scene on a user interface (UI), one or more land masses on the world map may be displayed on the UI. For example, one or more land masses where a player-controlled virtual character or a virtual pet character is currently located on the world map, as well as some interface elements related to the land masses, the player-controlled virtual character, the virtual pet character, and the like are displayed on the UI.

The battle scene refers to a scene corresponding to the battle map. During display of the battle scene on the UI, the battle map may be displayed on the UI. For example, all or some land masses on the battle map are displayed. For example, one or more land masses where the player-controlled virtual character or the virtual pet character is currently located on the battle map, as well as some interface elements related to the land masses, the player-controlled virtual character, the virtual pet character, and the like are displayed on the UI.

Switching between the virtual scene and the battle scene can be implemented, such as switching from the virtual scene to the battle scene, or switching from the battle scene to the virtual scene. A virtual camera may adopt different shooting perspectives during display of the virtual scene and the battle scene. For example, during display of the virtual scene, the virtual camera shoots the virtual scene from the perspective of the player-controlled virtual character (such as the first-person perspective or the third-person perspective of the player-controlled virtual character), to obtain a display image of the virtual scene. During display of the battle scene, the virtual camera shoots the battle scene from an intermediate perspective (for example, the virtual camera is positioned between and slightly above two parties engaging in a battle), to obtain a display image of the battle scene. In an embodiment, in the virtual scene and the battle scene, in addition to the shooting perspectives being different, allowed user operations may be different. For example, during display of the virtual scene, a user is allowed to manually adjust a camera angle, or the user is allowed to control movement of the player-controlled virtual character or the virtual pet character. During display of the battle scene, the user is not allowed to manually adjust the camera angle, or the user is not allowed to control movement of the player-controlled virtual character or the virtual pet character, or the like. In this manner, the user can make a perceptual distinction between the virtual scene and the battle scene. However, the virtual scene and the battle scene share the same world map, and the battle map used in the battle scene is one or more land masses on the world map. Therefore, the switching between the virtual scene and the battle scene does not cause a strong sense of disconnection. Instead, it is a smooth and natural transition.

Virtual environment: It refers to a virtual environment displayed (or provided) when an application program runs on a terminal. The virtual environment may be a simulated environment of a real world, a semi-simulated semi-fictional environment, or a purely-fictional environment. The virtual world may be any one of a two-dimensional virtual world, a 2.5-dimensional virtual world, and a three-dimensional virtual world. This is not limited in this application. In the following embodiments, a description is made by using an example a virtual world is a three-dimensional virtual world.

Player-controlled virtual character: It refers to a movable object played by a player in the virtual world. The player-controlled virtual character may be a virtual person, a virtual animal, or an animated person, such as a person or an animal displayed in a three-dimensional virtual world. In an embodiment, the player-controlled virtual character is a three-dimensional model created through the skeletal animation technology. Each player-controlled virtual character has its own shape and size in the three-dimensional virtual world and occupies a part of the space in the three-dimensional virtual world.

Virtual pet character: It refers to a movable object controlled by artificial intelligence (AI) in the virtual world. The virtual pet character may be a virtual creature, a virtual animal, a virtual monster, a virtual sprite, a virtual pet, or the like, such as a movable object presented in the form of an animal or in another form in the three-dimensional virtual world. The player-controlled virtual character may perform at least one of interactive operations of capturing, raising, upgrading, and the like on the virtual pet character. The virtual pet character may assist the player-controlled virtual character in at least one of interactive operations of collecting, battling, changing a land mass, and the like.

Evolution chain: It refers to an evolution sequence of a plurality of evolution stages of the virtual pet character. Some virtual pet characters typically have an evolution capability. For example, the virtual pet character has three evolution stages. When the virtual pet character evolves from a lower evolution stage to a higher evolution stage, a battle capability of the virtual pet character is enhanced correspondingly. In terms of numerical values, the virtual pet character has been comprehensively enhanced in aspects such as a speed, attack power, defense, and health points. In addition, in terms of interface presentation, visual factors, such as an appearance, a name, and a size, of the virtual pet character change. For example, the virtual pet character before evolution and the virtual pet character after evolution share some similarities in appearance, but the virtual pet character after evolution typically has a more magnificent appearance. For example, the virtual pet character before evolution is a fledgling bird, and the virtual pet character after evolution is a giant roc. However, a name of the virtual pet character before evolution is significantly associated with a name of the virtual pet character after evolution. For example, the name of the virtual pet character before evolution is “small-sized pet”, and the name of the virtual pet character after evolution is “large-sized pet”. In terms of size, the virtual pet character after evolution typically has a larger size, to indicate that the virtual pet character after evolution has a stronger battle capability.

In an embodiment, evolution points may be accumulated for the virtual pet character in a manner such as controlling the virtual pet character to engage in a battle, using a pet growth prop (such as a potion or special food) for the virtual pet character, completing a specified task, and allowing natural time to pass. When a quantity of evolution points of the virtual pet character reaches a value required for a higher evolution stage, the virtual pet character evolves from the lower evolution stage to the higher evolution stage. Different virtual pet characters have different quantities of evolution stages. For example, for some virtual pet characters, it is set that the virtual pet characters have only two evolution stages, for most virtual pet characters, it is set that the virtual pet characters have three evolution stages, and for rarer virtual pet characters, it is set that the virtual pet characters have more than three evolution stages. Designing different quantities of evolution stages for different virtual pet characters can enrich pet evolution strategies and pet training plans. In addition, different quantities of evolution stages may be used as a criterion for evaluating the growth potential of the virtual pet character. A larger quantity of evolution stages indicates higher growth potential of the virtual pet character.

In an embodiment, for some virtual pet characters, evolution chains of the virtual pet characters intersect with each other. For example, after evolving, a pet A evolves into a pet B. After evolving, a pet C also evolves into the pet B. In this case, an evolution chain of the pet A and an evolution chain of the pet C intersect with each other. In an embodiment, a plurality of virtual pet characters undergo fusion evolution to become one virtual pet character.

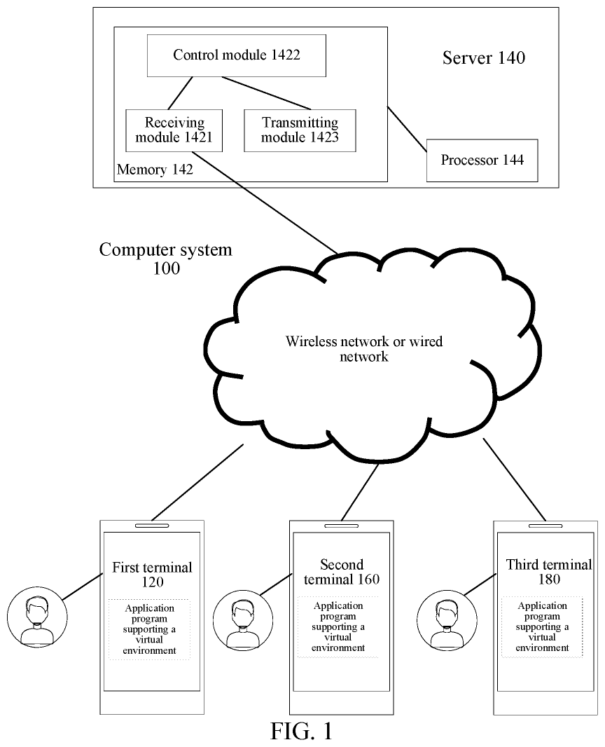

FIG. 1 is a structural block diagram of a computer system according to an exemplary embodiment of this application. A computer system 100 includes: a first terminal 120, a server 140, a second terminal 160, and a third terminal 180.

An application program supporting a virtual environment is equipped and run on the terminal 120. The application program may be any one of a three-dimensional map program, a virtual reality (VR) application program, an augmented reality (AR) program, an open-world game program, a role-playing game (RPG) program, a round-based game program, and a round-based RPG program. The first terminal 120 is a terminal used by a first user. The first user uses the first terminal 120 to control actions of a first virtual character in a virtual environment. The first virtual character serves as a first player-controlled virtual character. The actions include, but are not limited to, at least one of adjusting a body posture, walking, running, jumping, riding, driving, aiming, picking up, capturing a virtual pet character, controlling a virtual pet character, raising a virtual pet character, using a virtual pet character for picking, using a virtual pet character for a battle, using a throwing prop, and attacking another virtual character. Exemplarily, the first virtual object is at least one of a simulated person character, an animated person character, a virtual animal, and a virtual plant. Exemplarily, the first user controls the actions of the first virtual character through a UI control on a scene of the virtual environment. For example, the first user controls, through the UI control on the scene of the virtual environment, the first virtual character to throw a virtual pet character.

The first terminal 120 is connected to the server 140 via a wireless network or a wired network.

The server 140 includes at least one of a server, a plurality of servers, a cloud computing platform, or a virtualization center. Exemplarily, the server 140 includes a processor 144 and a memory 142. The memory 142 includes a receiving module 1421, a control module 1422, and a transmitting module 1423. The receiving module 1421 is configured to receive a request transmitted by a client, such as a request for obtaining a position of an opponent virtual character. The control module 1422 is configured to control rendering of the scene of the virtual environment. The transmitting module 1423 is configured to transmit a response to the client, for example, transmitting the position of the opponent virtual character. The server 140 is configured to provide a backend service for an application program supporting a three-dimensional virtual environment. In an embodiment, the server 140 undertakes primary computing work, and the first terminal 120, the second terminal 160, and the third terminal 180 undertake secondary computing work together. Alternatively, the server 140 undertakes secondary computing work, and the first terminal 120, the second terminal 160, and the third terminal 180 together undertake primary computing work. Alternatively, the server 140, the first terminal 120, the second terminal 160, and the third terminal 180 adopt a distributed computing architecture for collaborative computing.

An application program supporting a virtual environment is equipped and run on the second terminal 160. The second terminal 160 is a terminal used by a second user. The second user uses the second terminal 160 to control actions of a second virtual character in the virtual environment. The second virtual character serves as a second player-controlled virtual character. An application program supporting a virtual environment is equipped and run on the third terminal 180. The third terminal 180 is a terminal used by a third user. The third user uses the third terminal 180 to control actions of a third virtual character in the virtual environment. The third virtual character serves as a third player-controlled virtual character. In an embodiment, the first virtual character, the second virtual character, and the third virtual character are in the same virtual environment. The first virtual character, the second virtual character, and the third virtual character belong to different factions, or the first virtual character, the second virtual character, and the third virtual character belong to a same faction.

In an embodiment, the application programs equipped on the first terminal 120, the second terminal 160, and the third terminal 180 are the same, or the application programs equipped on the three terminals are the same type of application program on different operating system platforms (Android or iOS). The first terminal 120 may refer to one of a plurality of terminals, the second terminal 160 may refer to one of a plurality of terminals, and the third terminal 180 may refer to one of a plurality terminals. In this embodiment, a description is made by merely taking the first terminal 120, the second terminal 160, and the third terminal 180 as an example. Device types of the first terminal 120, the second terminal 160, and the third terminal 180 are the same or different. The device type includes at least one of a smartphone, a smart watch, a smart television, a tablet computer, a wearable device, an in-vehicle terminal, an e-book reader, a Moving Picture Experts Group Audio Layer III (MP3) player, a Moving Picture Experts Group Audio Layer IV (MP4) player, a laptop computer, and a desktop computer. In the following embodiments, a description is made by using an example in which a terminal includes a smartphone. A person skilled in the art may know that more or fewer terminals may be provided. For example, only one terminal may be provided, or dozens of, hundreds of, or more terminals may be provided. A quantity of terminals and a device type of the terminal are not specified in the embodiments of this application.

In the following, the player-controlled virtual character may be replaced with the first player-controlled virtual character controlled by the first user, and the virtual pet character may be replaced with a first virtual pet character corresponding to the first player-controlled virtual character. In an embodiment, a virtual pet character control method provided in this application is applicable to an open-world game. In the open-world game, a user controls actions of a player-controlled virtual character in a virtual scene, such as adjusting a body posture, walking, running, jumping, riding, driving, aiming, picking up, capturing a virtual pet character, controlling a virtual pet character, raising a virtual pet character, and using a virtual pet character for picking.

In response to a battle trigger event, a battle scene between a virtual pet character and an opponent pet character is displayed. For example, when the player-controlled virtual character encounters a wild pet character in the virtual scene and initiates a battles, the battle scene is displayed. This application provides a method for controlling a virtual pet character in a battle process.

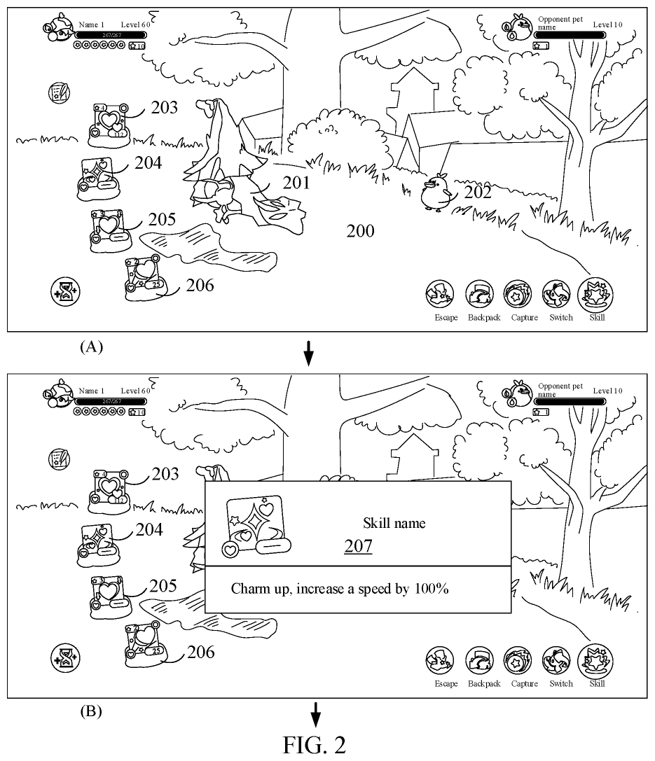

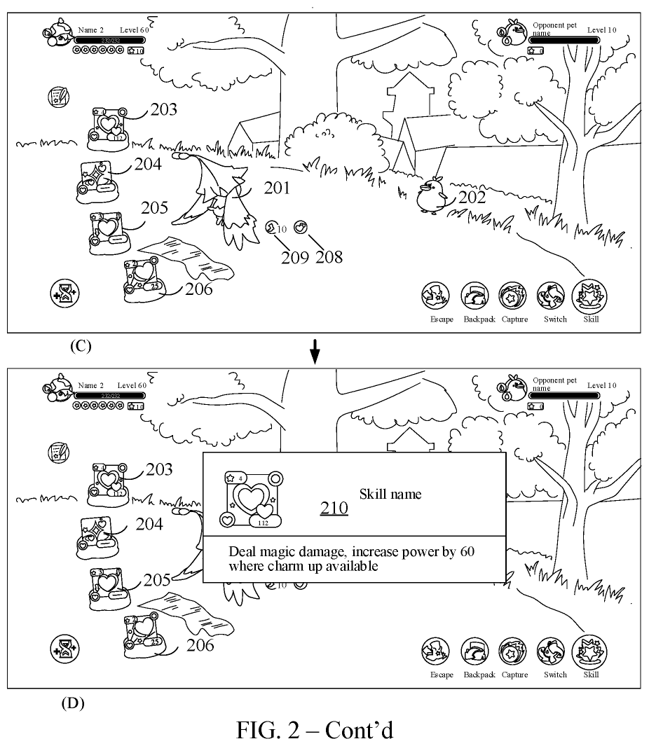

FIG. 2 is a schematic diagram of a virtual pet character control method according to an exemplary embodiment of this application. (A) in FIG. 2 shows an exemplary battle scene 200, in which a virtual pet character 201 battle against an opponent pet character 202. The virtual pet character 201 is a virtual character possess by a player-controlled virtual character (not shown in the figure), and the opponent pet character may be a virtual character possess by an opponent player-controlled virtual character, or may be a virtual character without an owner (namely, a wild virtual character). In an embodiment, the virtual pet character 201 and the opponent pet character 202 engage in a round-based battle. To be specific, the virtual pet character 201 and the opponent pet character 202 perform attack, defense, or capability improvement in turn according to a round sequence.

(A) in FIG. 2 shows a plurality of skill controls, including a skill control 203, a skill control 204, a skill control 205, and a skill control 206. The plurality of skill controls are in a one-to-one correspondence with a plurality of skills of the virtual pet character 201. In a round of the virtual pet character 201, when a skill casting condition is satisfied, the virtual pet character 201 may be controlled to cast a corresponding skill by triggering the skill control. In an embodiment, (B) in FIG. 2 shows a skill effect introduction window 207 of the skill control 204. The skill effect introduction window 207 indicates that a skill effect corresponding to the skill control 204 is “Charm up, increase a speed by 100%”. To be specific, the skill effect of the skill control 204 is: degenerating the current virtual pet character 201 to a previous evolution stage, to increase a moving speed by 100%.

Exemplarily, the virtual pet character 201 has three evolution stages, and a higher evolution stage indicates a stronger battle capability. In an embodiment, the virtual pet character is degenerated by one evolution stage each time the skill control 204 is triggered. In (A) and (B) in FIG. 2, the evolution stages of the virtual pet character 201 are all stage 3. In response to triggering the skill control 204 once, the evolution stage of the virtual pet character 201 is degenerated from stage 3 to stage 2. Stage 3 is an evolution stage higher than stage 2.

(C) in FIG. 2 shows the degenerated virtual pet character 201 in stage 2 after the skill control 204 is triggered. It may be found that the virtual pet character 201 in stage 3 in (A) in FIG. 2 has a more magnificent gorgeous and a larger size compared to the virtual pet character 201 in stage 2 in (C) in FIG. 2.

By comparing upper left corner areas in (A) and (C) in FIG. 2, it may further be found that the virtual pet character 201 in stage 3 before degeneration has a name 1, and the virtual pet character 201 in stage 2 after degeneration has a name 2. In other words, the virtual pet characters 201 in the two evolution stages have different names. Moreover, the virtual pet character 201 in stage 3 before degeneration has up to “267” health points, and the virtual pet character 201 in stage 2 after degeneration has up to “232” health points. In other words, maximum health points of the virtual pet characters 201 in the two evolution stages are also different.

In an embodiment, the virtual pet character 201 in stage 3 and the virtual pet character 201 in stage 2 have different appearances, names, sizes, and battle capabilities in at least two dimensions. The battle capabilities in at least two dimensions include at least two of an attack speed, a moving speed, attack power, defense power, health points, critical hit points, a critical hit rate, and a dodge rate.

(C) in FIG. 2 further shows a first icon 208. The first icon 208 indicates that the virtual pet character 201 is in stage 2 after a degeneration operation is performed. To distinguish whether the virtual pet character 201 is originally in stage 2 or is degenerated to stage 2, this application further provides the first icon 208. The first icon 208 prompts, via an interface, a user whether the current virtual pet character 201 is obtained through degeneration. In an embodiment, the first icon 208 further carries prompt information indicating a quantity of degeneration tiers. In (C) in FIG. 2, the absence of a number at a lower right corner of the first icon 208 indicates that the current virtual pet character 201 has only one degeneration tier, that is, the current virtual pet character 201 is obtained through one degeneration. In some other cases, the presence of the number 2 at the lower right corner of the first icon 208 indicates that the current virtual pet character 201 has two degeneration tiers, that is, the current virtual pet character 201 is obtained through two degenerations.

FIG. 2 shows a manner of lowering the evolution stage through the skill corresponding to the skill control 204. In practical, the evolution stage may be lowered through another skill of the virtual pet character 201, or through a degeneration prop. This is not limited in this application. (C) in FIG. 2 further shows a second icon 209. The second icon 209 indicates that a battle capability of the virtual pet character 201 in a first aspect is enhanced. In an embodiment, the first aspect may be at least one of an attack speed, a moving speed, attack power, defense power, health points, critical hit points, a critical hit rate, and a dodge rate. The second icon 209 indicates that a moving speed of the virtual pet character 201 is increased by 10 tiers, and each tier corresponds to a 10% increase in the moving speed. It can be known from the foregoing introduction that the effect of the skill control 204 is “Charm up, increase a speed by 100%”. It may be understood that, “increase a speed by 100%” is improvement relative to the virtual pet character 201 in stage 2 after degeneration. To be specific, the moving speed of the virtual pet character 201 in stage 2 after degeneration is increased by 100%, and the increased moving speed of the virtual pet character 201 in stage 2 is greater than the moving speed of the virtual pet character 201 in stage 3 before degeneration.

In this application, enhancement of the battle capability in the first aspect is obtained by degenerating to a lower evolution stage. In other words, this application provides available resource costs, namely, “evolution stages”, and enhancement of the battle capability in the first aspect is obtained by consuming the evolution stage, to affect the battle between the virtual pet character 201 and the opponent pet character 202.

(D) in FIG. 2 further shows a skill effect introduction window 210 of the skill control 203. The skill effect introduction window 210 indicates that a skill effect of the skill control 203 is “Deal magic damage, increase power by 60 where charm up available”. If the skill control 203 is triggered, magic damage is caused to the opponent pet character 202. In addition, because the current virtual pet character 201 is the virtual pet character 201 in stage 2 after degeneration, power of the virtual pet character is additionally increased by 60. In an embodiment, one degeneration tier is consumed each time the skill control 203 is triggered. To be specific, after the skill control 203 is triggered, one degeneration tier originally belonging to the virtual pet character 201 in stage 2 after degeneration is reduced to zero. The quantity of degeneration tiers refers to a quantity of degenerations.

In an embodiment, for the skill control 205, a skill effect of the skill control 205 is “Remove charm up, each charm-up tier increases attack, defense, and a speed by 10%”. To be specific, after the skill control 205 is triggered, each degeneration tier corresponds to a 10% increase in attack, defense, and the speed. In addition, all degeneration tiers are consumed at once. After the skill control 205 is triggered, on the interface, display is further switched from the virtual pet character 201 in stage 2 to the virtual pet character 201 in stage 3.

In the embodiments of this application, the virtual pet character is degenerated to a lower evolution stage, to enable the virtual pet character 201 to be in a degenerated state and have degeneration tiers. Through the degenerated state and the degeneration tiers, a trigger effect of another battle resource (such as a skill, similarly, and a virtual prop as well) may be enhanced. In other words, this application provides novel resource costs, namely, “evolution stages”, and the virtual pet character 201 is enabled to be in the degenerated state and have the degeneration tiers by consuming the “evolution stage”. Further, when combined with another battle resource, the generation tiers can enhance a battle effect of the another battle resource, to achieve an effect with a higher intensity.

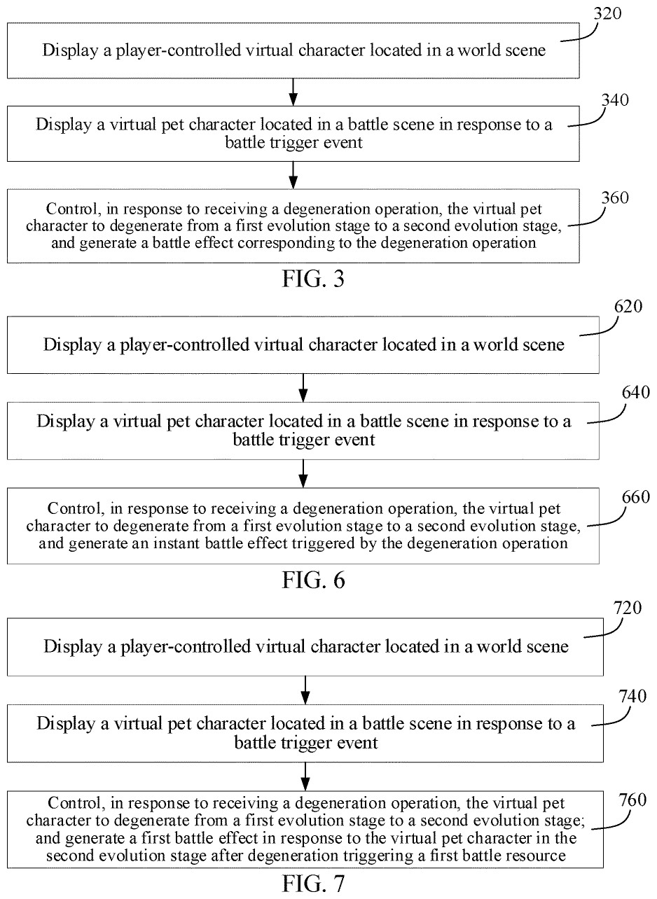

FIG. 3 is a flowchart of a virtual pet character control method according to an exemplary embodiment of this application. A description is made by using an example in which the method is performed by the first terminal 120 in FIG. 1. The method includes:
Operation 320: Display a player-controlled virtual character located in a virtual scene. In some embodiments, the player-controlled virtual character is associated with an account of a computer game and operates in response to user instructions on the graphical user interface of the virtual scene.

The virtual scene refers to a scene corresponding to a world map in an open-world game. A player may control, on the world map, the player-controlled virtual character to perform an exploration activity, for example, control the player-controlled virtual character to perform at least one of adjusting a body posture, walking, running, jumping, riding, driving, aiming, picking up, capturing a virtual pet character, controlling a virtual pet character, raising a virtual pet character, and using a virtual pet character for picking.

In an embodiment, the world map includes a castle, a marketplace, a commercial street, a park, a forest, a mountain slope, a volcano, a harbor, and a beach. The world map is a map network extended from a plurality of scenic spots serving as key nodes. In an embodiment, because the world map has many map resources for the player to explore, the world map is also referred to as a “big world”. The player-controlled virtual character refers to a movable object played by the player in a virtual world. The player-controlled virtual character may be a virtual person, a virtual animal, or an animated person. In the embodiments of this application, the player-controlled virtual character possesses a virtual pet character. In an embodiment, the virtual pet character serves as a companion of the player-controlled virtual character, and accompanies the player-controlled virtual character to explore in the virtual scene. In an embodiment, the virtual pet character and the player-controlled virtual character together battles against an opponent unit. In an embodiment, only the virtual pet character battles against the opponent unit. In an embodiment, the player-controlled virtual character release the virtual pet character by throwing a ball-like virtual prop, and the virtual pet character may interact with the player-controlled virtual character in the virtual scene. Exemplarily, in a process in which the player-controlled virtual character feeds the virtual pet character, the virtual pet character jumps up and down around the player-controlled virtual character, begging for more food from the player-controlled virtual character. Exemplarily, the virtual pet character picks a fruit in an environment, and delivers the fruit to the player-controlled virtual character. Exemplarily, when the player-controlled virtual character is about to barbecue, the virtual pet character sprays out flames. Exemplarily, the virtual pet character races against the player-controlled virtual character, and the like.

In an embodiment, the virtual pet character and the player-controlled virtual character have a companion growth mechanism, in which a level of the virtual pet character is affected by a level of the player-controlled virtual character. For example, the level of the virtual pet character cannot be higher than the level of the player-controlled virtual character.
Operation 340: Display a virtual pet character located in a virtual battle scene in response to a battle trigger event.

The virtual pet character is a virtual character belonging to the player-controlled virtual character. In an embodiment, the virtual pet character is a virtual character of a first category. In an embodiment, the first category is referred to as a “cute type”. The virtual pet character of the first category supports a degeneration operation for an evolution stage. In an embodiment, a manner of obtaining the virtual pet character includes at least one of the following: purchasing the virtual pet character from a shop, capturing the virtual pet character in the wild, obtaining the virtual pet character by completing a specified task, obtaining the virtual pet character as a level reward for the player-controlled virtual character, obtaining the virtual character as an event reward, breeding the virtual pet character, and the like.

In an embodiment, in the virtual scene, the virtual pet character is a virtual character controlled by AI. When the player-controlled virtual character explores in the virtual scene, the virtual pet character performs a series of actions around the player-controlled virtual character according to a control logic of the virtual pet character, such as patrolling around the player-controlled virtual character, helping the player-controlled virtual character clear obstacles, flying together with the player-controlled virtual character, and picking a fruit from a tree. In the battle scene, the virtual pet character has skills, and the player-controlled virtual character instructs/controls the virtual pet character to cast the skills. In this way, the virtual pet character battles against an opponent pet character. In an embodiment, the virtual pet character may be a virtual creature, a virtual animal, a virtual monster, a virtual sprite, or the like, such as a movable object presented in the form of an animal or in another form in a three-dimensional virtual world. In this application, the virtual pet character has an evolution chain, that is, the virtual pet character has a plurality of evolution stages. The virtual pet character in a higher evolution stage has a stronger battle capability compared to the virtual pet character in a lower evolution stage. The virtual pet character has at least a first evolution stage and a second evolution stage, the virtual pet character is currently in the first evolution stage, and the first evolution stage is higher than the second evolution stage. In an embodiment, the first evolution stage and the second evolution stage have a difference in at least one of the following content:
An appearance of the virtual pet character: Compared with the virtual pet character in the second evolution stage, the virtual pet character in the first evolution stage has a more magnificent appearance. For example, an appearance of the virtual pet character in the second evolution stage is a “fledgling bird”, and an appearance of the virtual pet character in the first evolution stage is a “mature giant roc”. From a difference in appearance, the user may perceive that the virtual pet character in a higher evolution stage has a stronger battle capability.
A name of the virtual pet character: Compared with the virtual pet character in the second evolution stage, the virtual pet character in the first evolution stage has a name indicating a more powerful semantic meaning. For example, a name of the virtual pet character in the second evolution stage is a “small-sized pet”, and a name of the virtual pet character in the first evolution stage is a “large-sized pet”. From a difference in name, the user may perceive that the virtual pet character in a higher evolution stage has a stronger battle capability.
An action of the virtual pet character: Exemplarily, when the virtual pet character in the second evolution stage performs a “flying” action, wings of the virtual pet character flap with a smaller amplitude. When the virtual pet character in the first evolution stage performs a flying action, wings of the virtual pet character flap with a larger amplitude. Therefore, from a difference in action, the user may perceive that the virtual pet character in a higher evolution stage has a stronger battle capability.
A size of the virtual pet character: The virtual pet character in the first evolution stage has a larger size, and the virtual pet character in the second evolution stage has a smaller sizer. The user may perceive that the virtual pet character in a higher evolution stage has a stronger battle capability. In an embodiment, the virtual pet character in the first evolution stage has a larger size, which indicates that the virtual pet character in the first evolution stage has a larger body weight. In some cases, damage to the opponent pet character is caused based on a body weight difference between a friendly virtual pet character and the opponent pet character. A larger body weight difference indicates higher damage caused.
Battle capabilities of the virtual pet character in at least two dimensions: The battle capabilities in at least two dimensions includes at least two of an attack speed, a moving speed, attack power, defense power, health points, critical hit points, a critical hit rate, and a dodge rate. In an embodiment, numerical values of the battle capabilities, in at least two dimensions, of the virtual pet character in the first evolution stage are comprehensively superior to those of the virtual pet character in the second evolution stage. The virtual pet character in a higher evolution stage has a stronger battle capability, which means that the virtual pet character in a higher evolution stage has more superior numerical values. However, through visual elements on the interface, the user may intuitively perceive the evolution stage and battle capability strength of the virtual pet character.

The battle trigger event refers to an event that triggers a battle. In an embodiment, the battle trigger event is an event in which the player-controlled virtual character encounters a wild pet character in the virtual scene. In an embodiment, the battle trigger event is an event in which the player-controlled virtual character encounters an opponent player-controlled virtual character in the virtual scene and initiates a battle. In an embodiment, the battle trigger event is an event in which the player-controlled virtual character arranges a battle with the opponent player-controlled virtual character in the virtual scene. In an embodiment, the battle trigger event is an event in which the player-controlled virtual character actively initiates a battle against the opponent player-controlled virtual character. Specific event content of the battle trigger event is not limited in this application.

In the embodiments of this application, in the battle scene, the virtual pet character of the player-controlled virtual character battles against the opponent pet character. The opponent pet character is a pet character belonging to the opponent player-controlled virtual character, or the opponent pet character is a pet character without an owner. In an embodiment, in the battle scene, the virtual pet character and the opponent pet character engage in a round-based battle. During the round-based battle, the virtual pet character and the opponent pet character perform attack, defense, or attribute improvement in turn according to a round sequence. This application provides the method for controlling the virtual pet character in a friendly round.

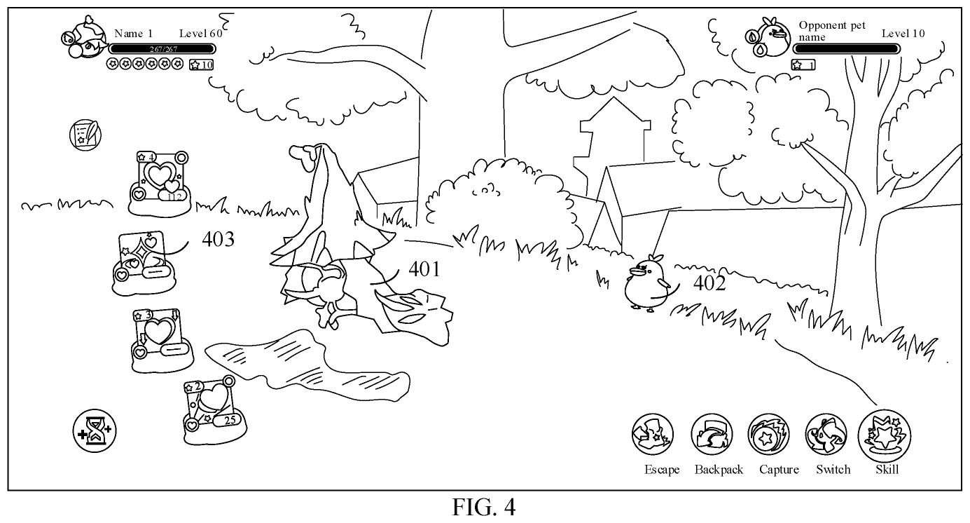

FIG. 4 shows a battle scene between a virtual pet character 401 in the first evolution stage and an opponent pet character 402. FIG. 4 further shows a degeneration skill control 403. The degeneration skill control 403 is configured to degenerate the virtual pet character 401 in the first evolution stage into the virtual pet character 401 in the second evolution stage.
Operation 360: Control, in response to receiving a degeneration operation, the virtual pet character to degenerate from a first evolution stage to a second evolution stage, and generate a battle effect corresponding to the degeneration operation.

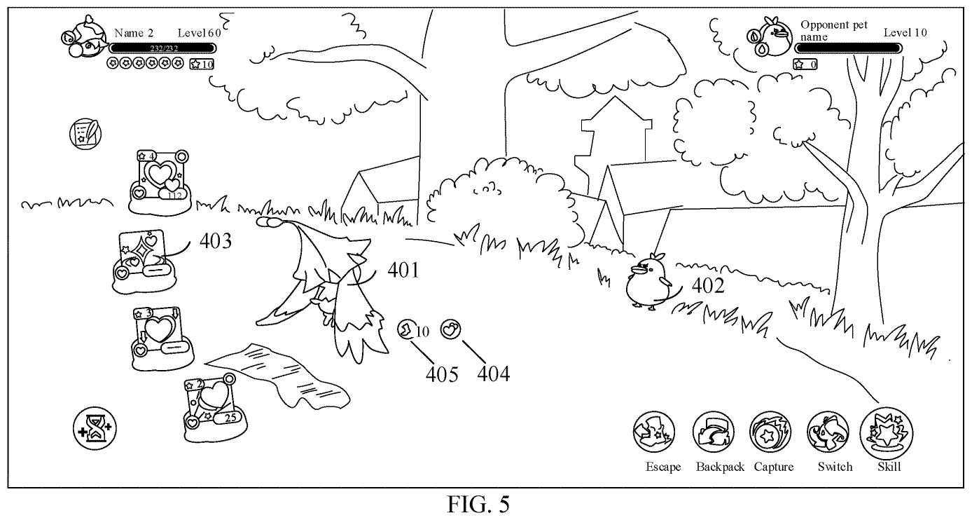

The degeneration operation refers to an operation configured for controlling the virtual pet character to degenerate from a higher evolution stage to a lower evolution stage. In an embodiment, the degeneration operation is implemented by triggering a degeneration skill control, and the degeneration skill control is configured to control the virtual pet character to cast a degeneration skill. FIG. 4 shows a degeneration skill control 403. A degeneration skill corresponding to the degeneration skill control 403 is configured for degenerating the virtual pet character 401 to a lower evolution stage. FIG. 5 shows the virtual pet character 401 in the second evolution stage after degeneration. As shown in FIGS. 4 and 5, the virtual pet character 401 in the second evolution stage is visually different from the virtual pet character 401 in the first evolution stage.

In an embodiment, n evolution stages exist between the first evolution stage and the second evolution stage. In an embodiment, the degeneration operation includes n degeneration trigger actions, the virtual pet character is degenerated by one evolution stage each time one degeneration trigger action is performed, and n is a positive integer. Exemplarily, the virtual pet character is degenerated by one evolution stage each time the degeneration skill control is triggered. In an embodiment, the n degeneration trigger actions may be triggered for n times for a same degeneration skill control, or may be triggered for a total of n times for a plurality of degeneration skill controls, and n is a positive integer.

In an embodiment, the degeneration operation includes one degeneration trigger action, and after the degeneration trigger action is performed, the virtual pet character is degenerated to a lowest evolution stage. Exemplarily, after the degeneration skill control is triggered once, the virtual pet character is degenerated from the first evolution stage to the second evolution stage. The second evolution stage is the lowest evolution stage in the evolution chain.

In an embodiment, the degeneration operation is implemented by using a degeneration prop. By using the degeneration prop for the virtual pet character, the virtual pet character is controlled to degenerate from the first evolution stage to the second evolution stage. The degeneration prop may be a virtual potion, a virtual pill, virtual food, or the like. In an embodiment, n evolution stages exist between the first evolution stage and the second evolution stage. In an embodiment, each degeneration prop is configured to degenerate the virtual pet character by one evolution stage, and the virtual pet character are degenerated by n evolution stages by using n degeneration props. In an embodiment, one degeneration prop is configured to degenerate the virtual pet character to a lowest evolution stage. In this case, the second evolution stage is the lowest evolution stage in the evolution chain.

The battle effect corresponding to the degeneration operation refers to a battle effect generated by the degeneration operation, and the battle effect is configured for affecting a battle between the virtual pet character and the opponent pet character. In this application, a specific battle effect is generated by lowering the evolution stage of the virtual pet character. In other words, this application provides resource costs, namely, “evolution stages”, and a specific battle effect may be obtained by consuming the evolution stage.

The battle effect acts on the battle between the player-controlled virtual character and the opponent pet character. In an embodiment, the battle effect includes a friendly battle effect and an opponent battle effect. The friendly battle effect refers to a battle effect that has a positive effect on a friendly faction. The opponent battle effect refers to a battle effect that has a negative effect on an opponent faction.

Exemplarily, the friendly battle effect includes enhancing a battle capability (such as a moving speed or health points) of the virtual pet character in a first aspect, increasing a quantity of friendly pets that can be fielded, increasing energy points of the virtual pet character (the energy points are a virtual resource required to be consumed when the virtual pet character casts a skill), additional attack (triggering a next attack twice), bonus damage (adding additional damage to the next attack), and the like.

Exemplarily, the opponent battle effect includes reducing a battle capability (such as health points or a moving speed) of the opponent pet character in a second aspect, skipping a next round of the opponent pet character, reducing energy points (the energy points are a virtual resource required to be consumed when the opponent pet character casts a skill) of the opponent pet character, degenerating the opponent pet character to a lower evolution stage, and the like.

In an embodiment, the battle effect includes a pet battle effect and a match battle effect. The pet battle effect refers to a battle effect acting on the friendly virtual pet character or the opponent pet character, and the match battle effect refers to a battle effect acting in a match dimension. Exemplarily, the pet battle effect includes enhancing a battle capability (such as a moving speed and health points) of the virtual pet character in a first aspect, reducing a battle capability (such as health points) of the opponent pet character in a second aspect, and the like. Exemplarily, the match battle effect includes skipping a next round of the opponent pet character, increasing round time of this round (a round of the virtual pet character), and the like.

In this embodiment of this application, through the degeneration operation, the virtual pet character is degenerated from a higher evolution stage (the first evolution stage) to a lower evolution stage (the second evolution stage), and the battle effect configured for affecting the battle between the virtual pet character and the opponent pet character is generated. In other words, this application provides resource costs, namely, “evolution stages”, and a specific battle effect is obtained by consuming the evolution stage of the virtual pet character. In addition, in the embodiments of this application, a method for transitioning between evolution stages is provided, which allows switching between different evolution stages to adapt to different battle scenes.

In the related art, most pets in a later stage of a game have evolved to a higher evolution stage, and resources related to a lower evolution stage, for example, art resources such as maps and skeletal models of virtual pet characters, are no longer used in the later stage of the game. In the related art, utilization of the resources related to the lower evolution stage in the later stage of the game is low. However, in this application, the evolution stage is used as a type of resource cost, and in the later stage of the game, the virtual pet character may be degenerated to the lower evolution stage through the degeneration operation. In this way, the resource related to the lower evolution stage can be used again, to improve utilization of the resource related to the lower evolution stage.

In conclusion, in the method according to the embodiments, through the degeneration operation, the virtual pet character is degenerated from a higher evolution stage (the first evolution stage) to a lower evolution stage (the second evolution stage), and the battle effect configured for affecting the virtual battle between the virtual pet character and the opponent pet character is generated. In this way, the evolution stage of the virtual pet character is implemented as a type of virtual resource, and a battle effect bonus is obtained by consuming the evolution stage of the virtual pet character. The evolution stage of the virtual pet character is implemented as a type of virtual resource, to provide a novel type of virtual resource in a virtual environment. This enriches types of virtual resources in the virtual environment. The virtual resource, namely, the evolution stage, is allocated through the degeneration operation. This enriches battle strategies in the virtual environment.

In an embodiment, a first icon is further displayed on the interface. The first icon indicates that the virtual pet character is in the second evolution stage after the degeneration operation is performed. To distinguish whether the virtual pet character is originally in the second evolution stage or is degenerated to the second evolution stage, this application further provides the first icon, and the first icon prompts the user, via the interface, whether the current virtual pet character is obtained through degeneration.

In an embodiment, the first icon further carries prompt information indicating a quantity of degeneration tiers and n evolution stages exist between the first evolution stage and the second evolution stage. If n is equal to 1, the first icon is further configured to prompt that the current virtual pet character in the second evolution stage is obtained through one degeneration. If n is greater than 1, the number n is further displayed on the first icon, to prompt that the current virtual pet character in the second evolution stage is obtained through n degenerations.

In an embodiment, a second icon is further displayed on the interface. The second icon indicates that the battle capability of the virtual pet character in the first aspect is enhanced. In an embodiment, the first aspect may be at least one of an attack speed, a moving speed, attack power, defense power, health points, critical hit points, a critical hit rate, and a dodge rate. A pattern of the second icon is associated with the first aspect. In an embodiment, the second icon further carries enhancement magnitude information. The enhancement magnitude information indicates an enhancement magnitude of the battle capability in the first aspect. For example, the numeral 10 is displayed on the second icon, which indicates that the battle capability in the first aspect is increased by 10 tiers. In an embodiment, each tier corresponds to an enhancement magnitude of 10%. Therefore, the 10 tiers correspond to an enhancement magnitude of 100%.

FIG. 5 is a schematic diagram of an interface after one trigger operation for a degeneration skill control 403 is received. A skill effect of the degeneration skill control 403 is “Charm up, increase a speed by 100%”. FIG. 5 shows a first icon 404. The first icon 404 is indicates that a current virtual pet character is obtained through degeneration. The absence of a number on the first icon 404 indicates that, by default, the current virtual pet character 401 in the second evolution stage after degeneration is obtained through one degeneration.

FIG. 5 further shows a second icon 405. The second icon 405 indicates that a moving speed of the virtual pet character is increased. The presence of the number 10 on the second icon 405 indicates that the moving speed is increased by 10 tiers. Each tier corresponds to a 10% increase in the moving speed. Therefore, the moving speed is increased by 100% in total.

It may be understood that, “increase a speed by 100%” is an increase relative to the virtual pet character 401 in the second evolution stage after degeneration. That is, the moving speed of the virtual pet character 401 in the second evolution stage after degeneration is increased by 100%, and the increased moving speed of the virtual pet character 401 in the second evolution stage is greater than a moving speed of the virtual pet character 401 in the first evolution stage before degeneration.

The following describes the “battle effect corresponding to the degeneration operation” in operation 360. The battle effect corresponding to the degeneration operation may be at least implemented as at least one of a first-type battle effect and a second-type battle effect.

### Regarding the First-Type Battle Effect

Based on the embodiment shown in FIG. 3, operation 360 is replaced with operation 660 shown in FIG. 6. FIG. 6 is a flowchart of a virtual pet character control method according to an exemplary embodiment of this application. A description is made by using an example in which the method shown in FIG. 6 is performed by the first terminal 120 in FIG. 1. Operation 620 in FIG. 6 is similar to operation 320, and operation 640 is similar to operation 340. Details are not described again.
Operation 660: Control, in response to receiving a degeneration operation, the virtual pet character to degenerate from a first evolution stage to a second evolution stage, and generate an instant battle effect triggered by the degeneration operation.

The instant battle effect is a battle effect triggered and generated upon degeneration of the virtual pet character. When the virtual pet character is degenerated from the first evolution stage to the second evolution stage, display is switched from the virtual pet character in the first evolution stage to the virtual pet character in the second evolution stage, and one instant battle effect is further generated. The instant battle effect is configured for affecting the battle between the virtual pet character and the opponent pet character. The instant battle effect refers to an effect that instantly affects the battle between the virtual pet character and the opponent pet character after the degeneration operation is performed.

In an embodiment, the degeneration operation includes a plurality of degeneration trigger actions, and one instant battle effect is obtained each time the degeneration trigger action is performed. In an embodiment, the degeneration operation includes one degeneration trigger action, and the virtual pet character is degenerated from a current evolution stage to a lowest evolution stage in the evolution chain each time the degeneration trigger action is performed.

Four methods for obtaining the instant battle effect are provided below.
Method 1: Control, in response to receiving the degeneration operation, the virtual pet character to degenerate from the first evolution stage to the second evolution stage, and enhance a battle capability of the virtual pet character in a first aspect, the enhance battle capability of the virtual pet character in the first aspect is stronger than that of the virtual pet character in the first evolution stage.

The virtual pet character has battle capabilities in at least two dimensions, such as an attack speed, a moving speed, attack power, defense power, health points, critical hit points, a critical hit rate, and a dodge rate. The first aspect is at least one of a plurality of aspects. For example, the battle capability in the first aspect is a moving speed.

In an embodiment, the virtual pet character is degenerated from the first evolution stage to the second evolution stage by comprehensively reducing the battle capability in at least two dimensions, and then the battle capability of the virtual pet character in the first aspect is enhanced.

In an embodiment, the degeneration operation includes n degeneration trigger actions. Exemplarily, in response to receiving a trigger operation for a first degeneration skill control, the virtual pet character is controlled to degenerate from a (k+n)^{th} evolution stage to a (k+n−1)^{th} evolution stage, and a moving speed of the virtual pet character is increased. Then, in response to receiving a trigger operation for a second degeneration skill control, the virtual pet character is controlled to degenerate from the (k+n−1)^{th} evolution stage to a (k+n−2)^{th} evolution stage, and health points of the virtual pet character are increased. By analogy, the virtual pet character is degenerated to the second evolution stage. The second evolution stage cannot be lower than the lowest evolution stage in the evolution chain.

Exemplarily, the degeneration skill control may be triggered by tapping the degeneration skill control once, by tapping the degeneration skill control twice, by sliding the degeneration skill control, or the like through a finger. Exemplarily, the degeneration skill control may alternatively triggered by clicking the degeneration skill control through a mouse, by pressing a shortcut key of the degeneration skill control through a keyboard, or the like. Exemplarily, the degeneration skill control may be triggered by at least one of a gesture operation, a voice operation, an eye-tracking operation, a gamepad operation, and the like.

In the embodiments of this application, available resource costs, namely, “evolution stages”, are provided. The battle capability of the virtual pet character in the first aspect is enhanced by consuming the evolution stage, to affect the battle between the virtual pet character and the opponent pet character.
Method 2: Control, in response to receiving the degeneration operation, the virtual pet character to degenerate from the first evolution stage to the second evolution stage, and energy points of the virtual pet character are increased, the energy points being a virtual resource required to be consumed when the virtual pet character casts a skill.

In an embodiment, each virtual pet character has energy points, the energy points have an upper limit, the virtual pet character needs to consume the energy points to cast a skill, and different quantities of energy points are required for different skills. When remaining energy points of the virtual pet character are less than energy points required for a specific skill, the skill cannot be cast. More content about the energy points is introduced in detail below.

In the embodiments of this application, available resources cost, namely, “evolution stages”, are provided. More energy points are obtained by consuming the evolution stage, to affect the battle between the virtual pet character and the opponent pet character.
Method 3: Control, in response to receiving the degeneration operation, the virtual pet character to degenerate from the first evolution stage to the second evolution stage, and reduce a battle capability of the opponent pet character in a second aspect.

The opponent pet character has battle capabilities in at least two dimensions, such as an attack speed, a moving speed, attack power, defense power, health points, critical hit points, a critical hit rate, and a dodge rate. The second aspect is at least one of a plurality of aspects. For example, the battle capability in the second aspect is health points.

In an embodiment, the virtual pet character is degenerated from the first evolution stage to the second evolution stage by comprehensively reducing the battle capabilities in at least two dimensions, and meanwhile, damage is caused once to the opponent pet character, that is, the health points of the opponent pet character are reduced. In an embodiment, damage caused by degeneration from the first evolution stage to the second evolution stage is greater than damage caused by an ordinary skill. The ordinary skill refer to a skill other than the degeneration skill.

The reducing the battle capability of the opponent pet character is similar to the foregoing enhancing the battle capability of the virtual pet character in the first aspect, and details are not described herein again.

In the embodiments of this application, available resource costs, namely, “evolution stages”, are provided. The battle capability of the opponent pet character in the second aspect is reduced by consuming the evolution stage, to affect the battle between the virtual pet character and the opponent pet character.
Method 4: Control, in response to receiving the degeneration operation, the virtual pet character to degenerate from the first evolution stage to the second evolution stage, and reduce energy points of the opponent pet character.

The energy points are a virtual resource required to be consumed when the opponent pet character casts a skill.

In an embodiment, the opponent pet character has the energy points, the energy points have an upper limit, the opponent pet character needs to consume the energy points to cast a skill, and different quantities of energy points are required for different skills. When remaining energy points of the opponent pet character are less than energy points required for a specific skill, the skill cannot be cast.

In the embodiments of this application, available resource costs, namely, “evolution stages”, are provided. The energy points of the opponent pet character are reduced by consuming the evolution stage, to affect the battle between the virtual pet character and the opponent pet character.

When at least two evolution stages exist between the first evolution stage and the second evolution stage, the method 1, the method 2, the method 3, and the method 4 may be separately used repeatedly, or may be used in combination, and finally, the virtual pet character in the first evolution stage is degenerated to the virtual pet character in the second evolution stage. If the foregoing methods are used in combination, a mixed effect of instant battle effects obtained by using a plurality of methods may be obtained.

For example, two evolution stages exist between the first evolution stage and the second evolution stage. The virtual pet character in stage 3 is degenerated to the virtual pet character in stage 2 by triggering a skill control 1, and a moving speed of the virtual pet character is increased. Then, the virtual pet character in stage 2 is degenerated to the virtual pet character in stage 1 by triggering a skill control 2, and energy points of the virtual pet character are increased.

### Regarding the Second-Type Battle Effect

Based on the embodiment shown in FIG. 3, operation 360 is replaced with operation 760 shown in FIG. 7. FIG. 7 is a flowchart of a virtual pet character control method according to an exemplary embodiment of this application. A description is made by using an example in which the method shown in FIG. 7 is performed by the first terminal 120 in FIG. 1. Operation 720 in FIG. 7 is similar to operation 320, and operation 740 is similar to operation 340. Details are not described again.
Operation 760: Control, in response to receiving a degeneration operation, the virtual pet character to degenerate from a first evolution stage to a second evolution stage; and generate a first battle effect in response to the virtual pet character in the second evolution stage after degeneration triggering a first battle resource.

In an embodiment, the degeneration operation includes a plurality of degeneration trigger actions, the virtual pet character is degenerated by one evolution stage each time the degeneration trigger action is performed, and one degeneration tier is obtained. In an embodiment, the degeneration operation includes one degeneration trigger action, the virtual pet character is degenerated from a current evolution stage to a lowest evolution stage each time the degeneration trigger action is performed, and degeneration tiers corresponding to a stage difference between the evolution stage before degeneration and the evolution stage after degeneration.

A quantity of degeneration tiers refers to a quantity of degenerations of the virtual pet character.

Exemplarily, the virtual pet character in the first evolution stage before degeneration has j degeneration tiers, the virtual pet character in the second evolution stage after degeneration has j+n degeneration tiers, and n denotes a quantity of evolution stages existing between the first evolution stage and the second evolution stage. In an embodiment, j is a non-negative integer, and n is a positive integer.

The first battle resource refers to a resource configured for affecting a battle between the virtual pet character and the opponent pet character. Exemplarily, the first battle resource may be a skill, a virtual prop, or the like.

When the first battle resource is triggered, an effect is generated for the battle between the two parties. If a current virtual pet character is a degenerated virtual pet character, the effect of the first battle resource is enhanced. The first battle effect is a battle effect that is generated when the virtual pet character in the second evolution stage after degeneration triggers the first battle resource, and a second battle effect is a battle effect that is generated when the virtual pet character in the first evolution stage before degeneration triggers the first battle resource, and an intensity of the first battle effect is higher than that of the second battle effect.

Exemplarily, one degeneration tier is consumed each time the first battle resource is triggered. Alternatively, currently existing degeneration tiers are all consumed each time the first battle resource is triggered, and a larger quantity of consumed degeneration tiers indicates a higher intensity of the first battle effect.

Two methods for obtaining the first battle effect are provided below.
Method 5: Generate a first skill effect in response to the virtual pet character in the second evolution stage after degeneration casting a first skill, an intensity of the first skill effect being higher than that of a second skill effect; and the second skill effect being an effect generated when the virtual pet character in the first evolution stage before degeneration casts the first skill.

Exemplarily, an effect of the first skill is “Deal magic damage, increase power by 60 where charm up available”. To be specific, compared to the power of the virtual pet character that is not degenerated and that casts the skill, the power of the virtual pet character that is degenerated to the second evolution stage and that casts the skill is increased by 60.

In an embodiment, currently existing degeneration tiers are all consumed each time the first skill is triggered, and a larger quantity of consumed degeneration tiers indicates a higher intensity of the first skill effect. Exemplarily, an effect of the first skill is “Remove charm up, and each charm-up tiers increases attack, defense, and a speed by 10%”. If the virtual pet character in the second evolution stage after degeneration casts the skill, because the virtual pet character in the second evolution stage after degeneration has j+n degeneration tiers, attack, defense, and the speed are increased by 10%*(j+n).

In the embodiments of this application, further, the degeneration tiers are used as resource costs, and the skill effect corresponding to the first skill may be enhanced by consuming the degeneration tier. In addition, the degeneration tiers may alternatively be understood as another resource belonging to the virtual pet character, and the quantity of degeneration tiers may be used as another dimension for evaluating the strength of the virtual pet character. A virtual pet character possessing a larger quantity of degeneration tiers is stronger, and a virtual pet character possessing a smaller quantity of degeneration tiers is weaker.

In an embodiment, in response to the virtual pet character in the second evolution stage after degeneration casting the first skill, the virtual pet character in the second evolution stage after degeneration is restored to the virtual pet character in the first evolution stage before degeneration, and the first skill effect is generated.

In this embodiment, before the first skill effect is generated, the virtual pet character in a lower evolution stage after degeneration may be restored to the virtual pet character in a higher evolution before degeneration, to avoid mere numerical inflation in terms of effect and prevent a user from experiencing a sense of mismatch when a pet at a lower evolution stage casts a powerful skill.

In addition, this embodiment provides a method for exiting a degenerated state. After the first skill is cast, the virtual pet character in a lower evolution stage after degeneration is restored to the virtual pet character in a higher evolution stage before degeneration. This facilitates circulation and sustainability of the evolution stages serving as resource costs. After the virtual pet character in a lower evolution stage is restored to the virtual pet character in a higher evolution stage, the virtual pet character in a higher evolution stage may be subsequently degenerated again.
Method 6: Generate a first prop effect in response to the virtual pet character in the second evolution stage after degeneration using a first virtual prop, an intensity of the first prop effect being higher than that of a second prop effect; and the second prop effect being a prop effect generated when the virtual pet character in the first evolution stage before degeneration uses the first virtual prop.

Exemplarily, the first virtual prop is a virtual potion, and an effect of the virtual potion is “Increase attack power by 10, and additionally increase the attack power by 50 where charm up available”. To be specific, compared to the power of the virtual pet character who is not degenerated and who uses the virtual potion, the power of the virtual pet character who is in the second evolution stage after degeneration and who uses the virtual potion is increased by 50.

In an embodiment, currently existing degeneration tiers are all consumed each time the first virtual prop is used, and a larger quantity of consumed degeneration tiers indicates a higher intensity of the first prop effect. Exemplarily, an effect of the first virtual prop is “Remove charm up, each charm-up tier increases defense power by 10%”. If the virtual pet character in the second evolution stage after degeneration uses the first virtual prop, because the virtual pet character in the second evolution stage after degeneration has j+n degeneration tiers, the defense power is increased by 10%*(j+n).

In the embodiments of this application, further, the degeneration tiers are used as resource costs, and the prop effect corresponding to the first virtual prop may be enhanced by consuming the degeneration tier. In addition, the degeneration tiers may alternatively be understood as another resource belonging to the virtual pet character, and the quantity of degeneration tiers may be used as another dimension for evaluating the strength of the virtual pet character. A virtual pet character possessing a larger quantity of degeneration tiers is stronger, and a virtual pet character possessing a smaller quantity of degeneration tiers is weaker.

In an embodiment, in response to the virtual pet character in the second evolution stage after degeneration using the first virtual prop, the virtual pet character in the second evolution stage after degeneration is restored to the virtual pet character in the first evolution stage before degeneration, and the first prop effect is generated.

In this embodiment, the virtual pet character in a lower evolution stage after degeneration is restored to the virtual pet character in a higher evolution stage before degeneration while generating the first prop effect, which provides a method for exiting the degenerated state. The virtual prop not only can generate a strong prop effect, but also can reverse degeneration, which provides a logical method for exiting the degenerated state. In addition, the operation of exiting the degenerated state further facilitates circulation and sustainability of the evolution stages serving as resource costs. After the virtual pet character in a lower evolution stage is restored to the virtual pet character in a higher evolution stage, the virtual pet character in a higher evolution stage may be subsequently degenerated again.

When at least two evolution stage exist between the first evolution stage and the second evolution stage, and one degeneration tier is consumed each time the first battle resource is triggered, the method 5 and the method 6 may be separately used repeatedly, or may be used in combination, and finally, all degeneration tiers are consumed. If the two methods are used in combination, the battle effects obtained by using the two methods can be achieved.

Exemplarily, if two evolution stages exist between the first evolution stage and the second evolution stage, and the virtual pet character in the first evolution stage before degeneration has no degeneration tier, and the virtual pet character in the second evolution stage after degeneration has two degeneration tiers.

By triggering the skill control, one degeneration tier is consumed to enhance the skill effect of the first skill, and the virtual pet character in stage 3 is degenerated into the virtual pet character in stage 2. Then, by using the virtual prop, one degeneration tiers is consumed to enhance the prop effect of the virtual prop, and the virtual pet character in stage 2 is degenerated into the virtual pet character in stage 1.

Next, content related to an energy system is described.

In the embodiments of this application, each virtual pet character has energy points (also referred to as a virtual energy points), and the energy points of each virtual pet character have an upper limit, and the upper limit is a preset threshold, such as 10 energy points.

In one embodiment, the virtual pet character has a plurality of skills. For some of the skills, a corresponding quantity of energy points are consumed each time the skill is cast. For example, three energy points are required for casting a skill, and two energy points are required for casting another skill. In an embodiment, different quantities of energy points are required for different skills of the virtual pet character. In an embodiment, the same quantity of energy points are required for different skills of the virtual pet character. In an embodiment, the virtual pet character also has a skill that can be cast without the need for the energy points. In an embodiment, the degeneration skill is a skill that can be cast without the need for the energy points. The virtual pet character is degenerated to a previous evolution stage each time degeneration skill is triggered.

In an embodiment, the upper limit is a numerical value obtained through a plurality of experimental designs. In an embodiment, the upper limit may result in that the energy points of the virtual pet character are insufficient for casting a pet skill in a pet battle.

In the related art, for a round-based battle in an open-world game, a concept of skill points (PP points) is provided, and a specific quantity of skill points are required for casting one skill. In the related art, no matter how a pet casts a skill in a single battle, an upper limit of skill points is always not reached. In this case, the skill point in the related art is a false setting, and does not impose any substantial limitation on a quantity of times a skill can be used.

In this application, the upper limit of the energy points of the virtual pet character is not large, energy point allocation pressure exists in a single battle, a player cannot freely cast a pet skill, and the player needs to plan use of the energy points. Therefore, the energy system provided in this application can enrich battle strategies in the pet battle.

In an embodiment, a second skill of the virtual pet character is displayed. In response to the virtual pet character casting the second skill, the energy points of the virtual pet character are consumed according to energy points required to be consumed when the second skill is used.

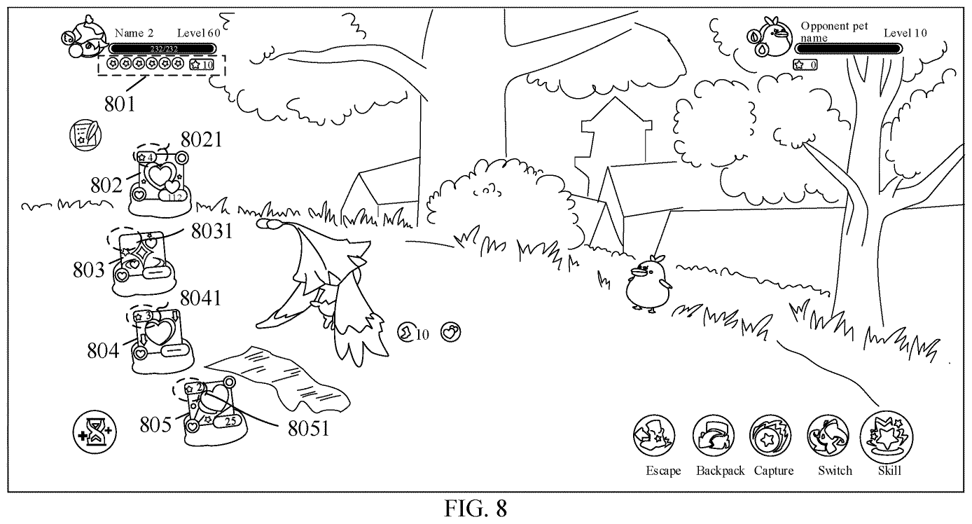

FIG. 8 shows an energy point area 801. The energy point area 801 is configured to display the energy points of the virtual pet character. In this case, the virtual pet character possesses ten energy points. In FIG. 8, an area 8021 shows that four energy points are required for casting a skill corresponding to a skill control 802, an area 8031 shows that no energy points are required for casting a skill corresponding to a skill control 803, an area 8041 shows that three energy points are required for casting a skill corresponding to a skill control 804, and an area 8051 shows that two energy points are required for casting a skill corresponding to a skill control 805.

In an embodiment, a third skill of the virtual pet character is displayed. In response to the virtual pet character casting the third skill, the energy points of the virtual pet character are restored according to an energy point restoration effect indicated by the third skill. In an embodiment, the energy point restoration effect indicated by the third skill may be restoring a specified quantity of energy points, or may be restoring to an upper limit value of possessable energy points. In an embodiment, the third skill is a skill that can be cast without the need for the energy points.

In the embodiments of this application, through the design of the energy system, a strategy for the virtual pet character in the battle is enhanced, and the players can properly allocate the energy points to formulate a battle strategy. In addition, the embodiments of this application further provide the method for evaluating skill strength based on the energy points, and a skill that consumes more energy points has a stronger skill effect.

In an embodiment, when a battle ends, the energy points of the virtual pet character are not automatically restored. Exemplarily, after a current battle ends, the virtual pet character possesses two energy points. If a next battle immediately starts, the virtual pet character possesses only two energy points at the beginning of the next battle.

In an embodiment, the player-controlled virtual character is controlled to move in the virtual scene; and the energy points of the virtual pet character are restored in response to performing a save operation at a specified position in the virtual scene. A save position exists in the virtual scene. After the player-controlled virtual character is moved to the save position, a current game process may be saved. In an embodiment, after the save operation is performed, the energy points of the virtual pet character are automatically restored to the upper limit.

In an embodiment, when the virtual pet character evolves from a lower evolution stage to a higher evolution stage, the energy points of the virtual pet character are restored to the upper limit. In an embodiment, for a newly obtained pet, a quantity of energy points of the pet is an upper limit.

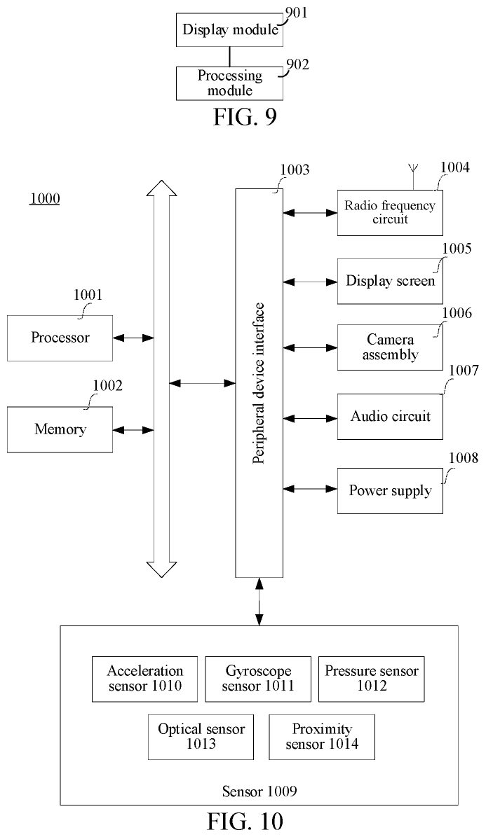

FIG. 9 is a structural block diagram of a virtual pet character control apparatus according to an exemplary embodiment of this application. The apparatus includes:
a display module 901, configured to perform operation 320 and operation 340 in the embodiment shown in FIG. 3, the virtual pet character being a virtual character belonging to the player-controlled virtual character, the virtual pet character having a first evolution stage and a second evolution stage, the virtual pet character being currently in the first evolution stage, and the first evolution stage being higher than the second evolution stage; and
a processing module 902, configured to perform operation 360 in the embodiment shown in FIG. 3, the battle effect being configured for affecting a battle between the virtual pet character and an opponent pet character.

In an embodiment, the processing module 902 is further configured to perform operation 660 in the embodiment in FIG. 6, the instant battle effect being a battle effect triggered and generated upon degeneration of the virtual pet character.

In an embodiment, the processing module 902 is further configured to control, in response to receiving the degeneration operation, the virtual pet character to degenerate from the first evolution stage to the second evolution stage, and enhance a battle capability of the virtual pet character in a first aspect.

In an embodiment, the processing module 902 is further configured to control, in response to receiving the degeneration operation, the virtual pet character to degenerate from the first evolution stage to the second evolution stage, and increase energy points of the virtual pet character, the energy points being a virtual resource required to be consumed when the virtual pet character casts a skill.

In an embodiment, the processing module 902 is further configured to control, in response to receiving the degeneration operation, the virtual pet character to degenerate from the first evolution stage to the second evolution stage, and reduce a battle capability of the opponent pet character in a second aspect.

In an embodiment, the processing module 902 is further configured to control, in response to receiving the degeneration operation, the virtual pet character to degenerate from the first evolution stage to the second evolution stage, and reducing energy points of the opponent pet character, the energy points being a virtual resource required to be consumed when the opponent pet character casts a skill.

In an embodiment, n evolution stages exist between the first evolution stage and the second evolution stage. The degeneration operation includes n degeneration trigger actions, one instant battle effect is obtained each time the degeneration trigger action is performed, and n is a positive integer.

In an embodiment, the processing module 902 is further configured to perform operation 760 in the embodiment shown in FIG. 7, an intensity of the first battle effect is higher than that of a second battle effect; and the second battle effect being a battle effect generated when the virtual pet character in the first evolution stage before degeneration triggers the first battle resource.

In an embodiment, the processing module 902 is further configured to generate a first skill effect in response to the virtual pet character in the second evolution stage after degeneration casting a first skill, an intensity of the first skill effect being higher than that of a second skill effect; and the second skill effect being an effect generated when the virtual pet character in the first evolution stage before degeneration casts the first skill.

In an embodiment, the processing module 902 is further configured to restore, in response to the virtual pet character in the second evolution stage after degeneration casting the first skill, the virtual pet character in the second evolution stage after degeneration to the virtual pet character in the first evolution stage before degeneration, and generate the first skill effect.

In an embodiment, the processing module 902 is further configured to generate a first prop effect in response to the virtual pet character in the second evolution stage after degeneration using the first virtual prop, an intensity of the first prop effect being higher than that of the second prop effect.

The second prop effect is a prop effect generated when the virtual pet character in the first evolution stage before degeneration uses the first virtual prop.

In an embodiment, the processing module 902 is further configured to restore, in response to the virtual pet character in the second evolution stage after degeneration using a first virtual prop, the virtual pet character in the second evolution stage after degeneration to the virtual pet character in the first evolution stage before degeneration, and generate a first prop effect.

In an embodiment, the virtual pet character in the first evolution stage before degeneration has j degeneration tiers, the virtual pet character in the second evolution stage after degeneration has j+n degeneration tiers, and n denotes a quantity of evolution stages existing between the first evolution stage and the second evolution stage.

One degeneration tier is consumed each time the first battle resource is triggered. Alternatively, currently existing degeneration tiers are all consumed each time the first battle resource is triggered, a larger quantity of consumed degeneration tiers indicates a higher intensity of the first battle effect, n is a positive integer, and j is a non-negative integer.

In an embodiment, a difference exists between the first evolution stage and the second evolution stage in at least one of the following: an appearance of the virtual pet character; a name of the virtual pet character; an action of the virtual pet character; a size of the virtual pet character; and battle capabilities of the virtual pet character in at least two dimensions, the battle capabilities in at least two dimensions including at least two of an attack speed, a moving speed, attack power, defense power, health points, critical hit points, a critical hit rate, and a dodge rate.

In an embodiment, the degeneration operation is implemented by triggering a degeneration skill control, and the degeneration skill control is configured to control the virtual pet character to cast a degeneration skill.

In an embodiment, the display module 901 is further configured to display a first icon, the first icon indicating that the virtual pet character is in the second evolution stage after the degeneration operation is performed.

In an embodiment, the display module 901 is further configured to display a second icon, the second icon indicating that the battle capability of the virtual pet character in the first aspect is enhanced.

In an embodiment, the display module 901 is further configured to display a second skill of the virtual pet character. The processing module 902 is further configured to consume, in response to the virtual pet character casting the second skill, the energy points of the virtual pet character according to energy points required for using the second skill.

In an embodiment, the energy points of the virtual pet character have an upper limit, and different quantities of energy points are required for different skills of the virtual pet character.

In an embodiment, the display module 901 is further configured to display a third skill of the virtual pet character. The processing module 902 is further configured to restore, in response to the virtual pet character casting the third skill, the energy points of the virtual pet character according to an energy point restoration effect indicated by the third skill.

In an embodiment, the processing module 902 is further configured to control the player-controlled virtual character to move in the virtual scene; and restore the energy points of the virtual pet character in response to performing a save operation at a specified position in the virtual scene.

In conclusion, in this application, through the degeneration operation, the virtual pet character is degenerated from a higher evolution stage (the first evolution stage) to a lower evolution stage (the second evolution stage), and the battle effect configured for affecting the battle between the virtual pet character and the opponent pet character is generated. In other words, this application provides resource costs, namely, “evolution stages”, and a specific battle effect is obtained by consuming the evolution stage of the virtual pet character. In a battle process, a player can plan the resource, namely, “evolution stage”, to formulate richer and more effective battle strategies. In addition, in the related art, most pets in a later stage of a game have evolved to a higher evolution stage, and resources related to a lower evolution stage, such as art resources, are no longer used in the later stage of the game. In the related art, utilization of the resources related to the lower evolution stage in the later stage of the game is low. However, in this application, the evolution stage is used as a type of resource cost, and in the later stage of the game, the virtual pet character may be degenerated to the lower evolution stage through the degeneration operation. In this way, the resource related to the lower evolution stage can be used again, to improve utilization of the resource related to the lower evolution stage.

FIG. 10 is a structural block diagram of a computer device 1000 according to an exemplary embodiment of this application. The computer device 1000 may be a portable mobile terminal, such as a smartphone, a tablet computer, an MP3 player, an MP4 player, a notebook computer, or a desktop computer. The computer device 1000 may alternatively be referred to as another name such as user equipment, a portable terminal, a laptop terminal, or a desktop terminal. Typically, the computer device 1000 includes: a processor 1001 and a memory 1002.

The processor 1001 may include one or more processing cores, such as a 4-core processor or an 8-core processor. The processor 1001 may be implemented in at least one hardware form of digital signal processor (DSP), a field-programmable gate array (FPGA), and a programmable logic array (PLA). The processor 1001 may alternatively include a main processor and a coprocessor. The main processor is a processor configured to process data in an awake state and is also referred to as a central processing unit (CPU). The coprocessor is a low-power processor configured to process data in a standby mode. In some embodiments, the processor 1001 may be integrated with a graphics processing unit (GPU). The GPU is configured to render and draw content that requires to be displayed on a display screen. In some embodiments, the processor 1001 may further include an AI processor. The AI processor is configured to process computing operations related to machine learning.

The memory 1002 may include one or more computer-readable storage media. The computer-readable storage media may be non-transitory. The memory 1002 may further include a high-speed random-access memory, a non-volatile memory, such as one or more disk storage devices and flash storage devices. In some embodiments, the non-transitory computer-readable storage medium in the memory 1002 is configured to store at least one instruction. The at least one instruction is executed by the processor 1001 to implement the virtual pet character control method according to the method embodiments of this application.

In some embodiments, the computer device 1000 may include: a peripheral device interface 1003 and at least one peripheral device. The processor 1001, the memory 1002, and the peripheral interface 1003 may be connected to each other via a bus or a signal cable. The peripheral device may be connected to the peripheral interface 1003 via a bus, a signal cable, or a circuit board. Exemplarily, the peripheral device may include at least one of a radio frequency (RF) circuit 1004, a display screen 1005, a camera assembly 1006, an audio circuit 1007, and a power supply 1008.

The peripheral device interface 1003 may be configured to connect at least one input/output (I/O)-related peripheral device to the processor 1001 and the memory 1002. In some embodiments, the processor 1001, the memory 1002, and the peripheral device interface 1003 are integrated on a same chip or circuit board. In some other embodiments, any one or two of the processor 1001, the memory 1002, and the peripheral device interface 1003 may be implemented on a separate chip or circuit board. This is not limited in this embodiment.

The RF circuit 1004 is configured to receive and transmit an RF signal, which is also referred to as an electromagnetic signal. The RF circuit 1004 communicates with a communication network and another communication device through the electromagnetic signal. The RF circuit 1004 converts an electrical signal into an electromagnetic signal for transmission, or converts a received electromagnetic signal into an electrical signal. In an embodiment, the RF circuit 1004 includes: an antenna system, an RF transceiver, one or more amplifiers, a tuner, an oscillator, a DSP, a codec chip set, a subscriber identity module card, and the like. The RF circuit 1004 may communicate with another terminal by using at least one wireless communication protocol. The wireless communication protocol includes, but is not limited to, a world wide web, a metropolitan area network, an intranet, various generations of mobile communication networks (2G, 3G, 4G, and 5G), a wireless local area network, and/or a Wireless Fidelity (Wi-Fi) network. In some embodiments, the RF circuit 1004 may further include a circuit related to near field communication (NFC). This is not limited in this application.

The display screen 1005 is configured to display a UI. The UI may include graphics, text, icons, videos, and any combination thereof. When the display screen 1005 is a touch display screen, the display screen 1005 further has a capability to collect a touch signal on or above a surface of the display screen 1005. The touch signal may be inputted, as a control signal, into the processor 1001 for processing. In this case, the display screen 1005 may be further configured to provide a virtual button and/or a virtual keyboard, which are/is referred to as a soft button and/or a soft keyboard. In some embodiments, one display screen 1005 may be disposed on a front panel of the computer device 1000. In some other embodiments, at least two display screens 1005 may be disposed respectively on different surfaces of the computer device 1000 or may be in a folded design. In some other embodiments, the display screen 1005 may be a flexible display screen disposed on a curved surface or a folded surface of the computer device 1000. Even, the display screen 1005 may be further provided in a non-rectangular irregular pattern, namely, a special-shaped screen. The display screen 1005 may be prepared from a material such as a liquid crystal display (LCD), an organic light-emitting diode (OLED), or the like.

The camera assembly 1006 is configured to collect an image or a video. In an embodiment, the camera assembly 1006 includes a front camera and a rear camera. Typically, the front camera is disposed on the front panel of the terminal, and the rear camera is disposed on a back surface of the terminal. In some embodiments, at least two rear cameras are provided, which are respectively any of a main camera, a depth camera, a wide-angle camera, and a telephoto camera, to achieve a background blurring function through the fusion of the main camera and the depth camera, panoramic shooting and VR shooting functions through the fusion of the main camera and the wide-angle camera, or other fusion-based shooting functions. In some embodiments, the camera assembly 1006 may further include a flash. The flash may be a single-color temperature flash or a dual-color temperature flash. The dual-color temperature flash refers to a combination of a warm-light flash and a cool-light flash, which may be configured to compensate light at different color temperatures.

The audio circuit 1007 may include a microphone and a speaker. The microphone is configured to collect sound waves from a user and the environment, and convert the sound waves into an electrical signal, which is then inputted into the processor 1001 for processing, or inputted into the RF circuit 1004 for voice communication. For the purpose of stereo sound collection or noise reduction, a plurality of microphones are respectively disposed at different parts of the computer device 1000. The microphone may be further an array microphone or an omnidirectional microphone. The speaker is configured to convert an electrical signal from the processor 1001 or the RF circuit 1004 into sound waves. The speaker may be a conventional thin-film speaker or a piezoelectric ceramic speaker. When the speaker is a piezoelectric ceramic speaker, the speaker not only can convert an electrical signal into sound waves audible to a human being, but also can convert an electrical signal into sound waves inaudible to the human being for a purpose such as ranging. In some embodiments, the audio circuit 1007 may further include a headphone jack.

The power supply 1008 is configured to supply power to the components of the computer device 1000. The power supply 1008 may be an alternating current, a direct current, a disposable battery, or a rechargeable battery. When the power supply 1008 includes a rechargeable battery, the rechargeable battery may be a wired rechargeable battery or a wireless rechargeable battery. The wired rechargeable battery refers to a battery charged through a wired cable. The wireless rechargeable battery refers to a battery charged through a wireless coil. The rechargeable battery may further support fast charging.

In some embodiments, the computer device 1000 further includes one or more sensors 1009. The one or more sensors 1009 include, but are not limited to, an acceleration sensor 1010, a gyroscope sensor 1011, a pressure sensor 1012, an optical sensor 1013, and a proximity sensor 1014.

The acceleration sensor 1010 may detect acceleration on three coordinate axes of a coordinate system established based on the computer device 1000. For example, the acceleration sensor 1010 may be configured to detect components of gravitational acceleration on the three coordinate axes. The processor 1001 may control the display screen 1005 to display the UI in a landscape view or a portrait view according to a gravitational acceleration signal collected by the acceleration sensor 1010. The acceleration sensor 1010 may alternatively be configured to collect motion data of a game or a user.

The gyroscope sensor 1011 may detect a body direction and a rotation angle of the computer device 1000. The gyroscope sensor 1011 may cooperate with the acceleration sensor 1010 to collect a three-dimensional (3D) action performed by the user on the computer device 1000. The processor 1001 may implement the following functions according to the data collected by the gyroscope sensor 1011: motion sensing (such as changing the UI according to a tilt operation of the user), image stabilization at shooting, game control, and inertial navigation.

The pressure sensor 1012 may be disposed on a side frame of the computer device 1000 and/or disposed under the display screen 1005. When the pressure sensor 1012 is disposed on the side frame of the terminal device 1000, a grip signal of the user on the terminal device 1000 may be detected. The processor 1001 performs left/right hand recognition or a quick operation according to the grip signal collected by the pressure sensor 1012. When the pressure sensor 1012 is disposed under the display screen 1005, the processor 1001 controls an operable control on the UI according to a pressure operation of the user on the display screen 1005. The operable controls include at least one of a button control, a scroll-bar control, an icon control, and a menu control.

The optical sensor 1013 is configured to collect an ambient light intensity. In an embodiment, the processor 1001 may control the display brightness of the display screen 1005 according to the ambient light intensity collected by the optical sensor 1013. Exemplarily, when the ambient light intensity is high, the display brightness of the display screen 1005 is increased. When the ambient light intensity is low, the display brightness of the display screen 1005 is decreased. In another embodiment, the processor 1001 may further dynamically adjust camera parameters of the camera assembly 1006 based on the ambient light intensity collected by the optical sensor 1013.

The proximity sensor 1014, also referred to as a distance sensor, is typically disposed on the front panel of the computer device 1000. The proximity sensor 1014 is configured to collect a distance between the user and a front surface of the computer device 1000. In an embodiment, when the proximity sensor 1014 detects that the distance between the user and the front surface of the computer device 1000 gradually decreases, the processor 1001 controls the display screen 1005 to switch from a screen-on state to a screen-off state. When the proximity sensor 1014 detects that the distance between the user and the front surface of the computer device 1000 gradually increases, the processor 1001 controls the display screen 1005 to switch from the screen-off state to the screen-on state.

A person skilled in the art may understand that the structure shown in FIG. 10 does not constitute a limitation on the computer device 1000, and the computer device may include more or fewer components than those shown in the figure, or some components may be combined, or a different component deployment may be used.

This application further provides a non-transitory computer-readable storage medium, having at least one instruction, at least one program, a code set, or an instruction set stored therein. The at least one instruction, the at least one program, the code set, or the instruction set is loaded and executed by a processor to implement the virtual pet character control method according to the foregoing method embodiments.

This application provides a computer program product or a computer program, including computer instructions. The computer instructions are stored in a computer-readable storage medium. A processor of a computer device reads the computer instructions from the computer-readable storage medium, and executes the computer instructions, to cause the computer device to perform the virtual pet character control method according to the foregoing method embodiments.

The sequence numbers of the foregoing embodiments of this application are merely for description, but do not indicate the preference among the embodiments.

A person of ordinary skill in the art may understand that all or part of the operations for implementing the foregoing embodiments may be implemented by using hardware, or may be implemented by a program instructing related hardware. The program may be stored in a computer-readable storage medium. The storage medium mentioned above may be a read-only memory, a magnetic disk, an optical disc, or the like.

In this application, the term “module” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules. In addition, each module may be a part of an overall module including a function of the module.

What is claimed is:

1. A method for controlling a virtual pet character in a virtual scene performed by a computer device, the method comprising:
displaying a graphical user interface including a virtual pet character located in a virtual scene, the virtual pet character having at least a first evolution stage and a second evolution stage, the virtual pet character being currently in the first evolution stage, and the first evolution stage being higher than the second evolution stage;
in response to receiving a degeneration operation, controlling the virtual pet character to degenerate from the first evolution stage to the second evolution stage and generating an instant battle effect corresponding to the degeneration operation for the virtual pet character, wherein the virtual pet character in the second evolution stage is visually different from the virtual pet character in the first evolution stage; and
applying the instant battle effect to enhance an attack launched by the virtual pet character against an opponent pet character.

2. The method according to claim 1, wherein the generating an instant battle effect corresponding to the degeneration operation for the virtual pet character comprises:
enhancing a battle capability of the virtual pet character in a first aspect,
the enhanced battle capability of the virtual pet character in the first aspect being stronger than that of the virtual pet character in the first evolution stage.

3. The method according to claim 1, wherein the generating an instant battle effect corresponding to the degeneration operation for the virtual pet character comprises:
increasing energy points of the virtual pet character,
the energy points being a virtual resource required to be consumed when the virtual pet character casts a skill.

4. The method according to claim 1, wherein the generating an instant battle effect corresponding to the degeneration operation for the virtual pet character comprises:
reducing a battle capability of the opponent pet character in a second aspect.

5. The method according to claim 1, wherein the generating an instant battle effect corresponding to the degeneration operation for the virtual pet character comprises:
reducing energy points of the opponent pet character,
the energy points being a virtual resource required to be consumed when the opponent pet character casts a skill.

6. The method according to claim 1, wherein n evolution stages exist between the first evolution stage and the second evolution stage; and
the degeneration operation comprises n degeneration trigger actions, one instant battle effect is obtained each time the degeneration trigger action is performed, and n is a positive integer.

7. The method according to claim 1, wherein a difference exists between the first evolution stage and the second evolution stage battle capabilities of the virtual pet character in at least two dimensions, the battle capabilities in at least two dimensions comprising at least two of an attack speed, a moving speed, attack power, defense power, health points, critical hit points, a critical hit rate, and a dodge rate.

8. The method according to claim 1, wherein the degeneration operation is implemented by triggering a degeneration skill control in the virtual scene, and the degeneration skill control is configured to control the virtual pet character to cast a degeneration skill.

9. The method according to claim 1, further comprising:
generating a first icon in the virtual scene, the first icon indicating that the virtual pet character is in the second evolution stage after the degeneration operation is performed.

10. The method according to claim 9, further comprising:
generating a second icon in the virtual scene, the second icon indicating that the virtual pet character in the second evolution stage has an enhanced battle capability.

11. The method according to claim 1, further comprising:
displaying a second skill of the virtual pet character in the virtual scene after the virtual pet character is degraded from the first evolution stage to the second evolution stage; and
in response to the virtual pet character casting the second skill at the opponent pet character, reducing a preset number of energy points of the virtual pet character according to energy points required for using the second skill.

12. The method according to claim 11, further comprising:
displaying a third skill of the virtual pet character in the virtual scene after the virtual pet character is degraded from the first evolution stage to the second evolution stage; and
in response to the virtual pet character casting the third skill at the opponent pet character, restoring a preset number of energy points of the virtual pet character according to an energy point restoration effect indicated by the third skill.

13. A computer device, comprising a processor and a memory, the memory having a computer program stored therein, the computer program, when loaded and executed by the processor, causing the computer device to implement a method for controlling a virtual pet character in a virtual scene, the method including:
displaying a graphical user interface including a virtual pet character located in a virtual scene, the virtual pet character having at least a first evolution stage and a second evolution stage, the virtual pet character being currently in the first evolution stage, and the first evolution stage being higher than the second evolution stage;
in response to receiving a degeneration operation, controlling the virtual pet character to degenerate from the first evolution stage to the second evolution stage and generating an instant battle effect corresponding to the degeneration operation for the virtual pet character, wherein the virtual pet character in the second evolution stage is visually different from the virtual pet character in the first evolution stage; and
applying the instant battle effect to enhance an attack launched by the virtual pet character against an opponent pet character.

14. The computer device according to claim 13, wherein the generating an instant battle effect corresponding to the degeneration operation for the virtual pet character comprises:
enhancing a battle capability of the virtual pet character in a first aspect,
the enhanced battle capability of the virtual pet character in the first aspect being stronger than that of the virtual pet character in the first evolution stage.

15. The computer device according to claim 13, wherein the generating an instant battle effect corresponding to the degeneration operation for the virtual pet character comprises:
increasing energy points of the virtual pet character,
the energy points being a virtual resource required to be consumed when the virtual pet character casts a skill.

16. The computer device according to claim 13, wherein the generating an instant battle effect corresponding to the degeneration operation for the virtual pet character comprises:
reducing a battle capability of the opponent pet character in a second aspect.

17. The computer device according to claim 13, wherein the generating an instant battle effect corresponding to the degeneration operation for the virtual pet character comprises:
reducing energy points of the opponent pet character,
the energy points being a virtual resource required to be consumed when the opponent pet character casts a skill.

18. The computer device according to claim 13, wherein n evolution stages exist between the first evolution stage and the second evolution stage; and
the degeneration operation comprises n degeneration trigger actions, one instant battle effect is obtained each time the degeneration trigger action is performed, and n is a positive integer.

19. The computer device according to claim 13, wherein a difference exists between the first evolution stage and the second evolution stage battle capabilities of the virtual pet character in at least two dimensions, the battle capabilities in at least two dimensions comprising at least two of an attack speed, a moving speed, attack power, defense power, health points, critical hit points, a critical hit rate, and a dodge rate.

20. A non-transitory computer-readable storage medium, having a computer program stored therein, the computer program, when loaded and executed by a processor of a computer device, causing the computer device to implement a method for controlling a virtual pet character in a virtual scene, the method including:
displaying a graphical user interface including a virtual pet character located in a virtual scene, the virtual pet character having at least a first evolution stage and a second evolution stage, the virtual pet character being currently in the first evolution stage, and the first evolution stage being higher than the second evolution stage;
in response to receiving a degeneration operation, controlling the virtual pet character to degenerate from the first evolution stage to the second evolution stage and generating an instant battle effect corresponding to the degeneration operation for the virtual pet character, wherein the virtual pet character in the second evolution stage is visually different from the virtual pet character in the first evolution stage; and
applying the instant battle effect to enhance an attack launched by the virtual pet character against an opponent pet character.
